(19) United States
(12) Patent Application Publication
(10) Pub. No.: US 2005/0131836 A1
(43) Pub. Date: Jun. 16, 2005

(54) Method, device and software for ordering and paying for a purchase

(76) Inventors: Thomas William Armstrong, Don Mills (CA); Donald Karl Isenor, North York (CA)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/735,089

(22) Filed: Dec. 12, 2003

(51) Int. Cl. H04L 9/00

(52) U.S. Cl. 705/64

(57) ABSTRACT

There is disclosed a method, device and software for allowing a buyer to order and pay for products with minimal action required on the part of the buyer. In an embodiment, a display component displays to the buyer a product available for purchase from a merchant through a merchant computing device. A purchase order component is configured to send to the merchant, in response to a single purchasing action taken by the buyer to purchase a product displayed by the display component, a purchase order for the product by way of a data network. A value storage component under control of the buyer stores data representative of a currency of an issuer, verifiable as representing the currency by the merchant. The value storage component is configurable to electronically transfer data representative of an amount of the currency in response to a request from the merchant.

### FIELD OF THE INVENTION

The invention relates to ordering and making payment for a purchase, and more particularly methods, devices and software for ordering and paying for a purchase using a single action.

### BACKGROUND OF THE INVENTION

Selecting and paying for goods or services over the Internet may involve many steps. A typical sequence at a typical merchant web site on the world-wide web may be as follows:
a) Merchant web site sends HTML pages, that describe the merchant's products, to buyer's web browser.
b) Buyer selects products which are added to a notional “shopping cart”. Buyer may then navigate to pages describing other products offered for sale by the merchant.
c) Steps a) and b) are repeated until the buyer has chosen all the products he wishes to purchase.
d) Buyer indicates that he wishes to “check out”, i.e. to pay for the products buyer has chosen and put into his shopping cart.
e) Merchant web site sends a check-out page to buyer's browser.
f) Buyer chooses a preferred payment technique (e.g. a credit card).
g) Merchant web site sends a page to solicit information relating to the payment technique (e.g., credit card number, PIN, expiry date, cardholder name, billing address).
h) Buyer fills in the page of information relating to the selected payment technique.
i) Merchant web site sends a page to solicit confirmation of the payment.
j) Buyer confirms the payment.
k) Merchant processes the payment.
l) Merchant arranges delivery of product to buyer.

Merchants wish to make it as easy as possible for buyers to purchase their products. One aspect of a purchase that can be particularly burdensome is payment. Many of the steps in the above time-consuming process relate to making payment. Merchants wish to reduce the effort which a buyer must expend in order to make a payment, since reducing this effort may lead to increased sales. This has led to the development of many techniques for reducing the work performed by a buyer to make a payment.

For example, one such technique is pre-authorized payment through a third party. After establishing an account with the third party, a buyer informs a merchant that it should take payment from the account, and directs the third party to pay the funds on receiving a request from the merchant. The account is one into which the buyer has previously deposited funds, or from which the buyer can draw credit.

This approach has some drawbacks. For example, it may take significant time and effort to set up this type of an account and make such a payment. Also, the pre-authorized payment mechanism is not under the buyer's control. The merchant may, accidentally or fraudulently, obtain funds from the third party which the buyer does not want to pay. The buyer may never discover this invalid payment, or may not discover it for a long period of time. Furthermore, it is often time consuming and difficult to prevent any future payments of this type from taking place. The buyer must communicate with both the merchant and the third party to terminate the previously authorized payments.

An approach to minimizing the effort needed to order a product is described in U.S. Pat. No. 5,960,411 (Hartman et al.). With this approach, primarily intended for use on the Internet, a merchant stores, in a computer database, information about how the buyer wishes to pay for purchases. The information may include, for example, credit card numbers and expiry dates, billing address, the buyer's name, and other information needed for marketing or security purposes. This information about the buyer is saved with a client identifier. In order to make a payment, the buyer identifies himself by using a keyboard to enter the client identifier. The merchant system uses the client identifier to locate the payment information and uses the payment information to effect payment.

This approach may reduce the effort to make a payment under certain circumstances, but also has certain drawbacks. For example, although entering a buyer ID and password is not much work compared to entering all the information needed to completely specify a payment, it may still be a lot of work to perform, especially if the transaction is intended to be very quick. Requiring a buyer to enter a user ID and password is a disproportionate amount of work to do, for example, when the payment is for a very small amount of money (e.g. 25 cents). Also, with this approach, the buyer must be known to the merchant in advance. At least once, probably on the first payment the buyer makes to a merchant, the buyer must enter detailed personal identification and payment information which the merchant then stores in its databases. The merchant needs to manage a lot of data about each buyer that wants to make payments in this manner. Furthermore, the personal data about each buyer that is stored by a merchant is, in many jurisdictions, subject to a privacy regime that gives the buyer rights to see and correct the data. Thus, the merchant must provide systems that enable a buyer to examine and alter the stored data. Buyers are also concerned about the security of the information stored by the merchant, and about the potential impact on their privacy should this data not be carefully protected.

As will be apparent, a particular drawback to the above mentioned approaches is lack of support for making payments anonymously. In each case the merchant must know about the buyer and the buyer's payment information before being able to perform a payment. Because payment cannot be made anonymously, one buyer may fraudulently pretend to be another buyer. This may lead to high fraud rates.

Also, systems dependent on buyer identification must also provide recourse—the ability for a buyer who has incorrectly been charged by a merchant to reverse the payment. Recourse means that even though a merchant believes it has been paid for its product, the payment may be cancelled and taken back at some indeterminate time in the future. This recourse requirement greatly complicates the design and operation of the payment service, and significantly increases its operating cost.

Micro-payments are small value payments, typically of amounts less than $10. If a buyer is making a small payment, then the buyer wants to make a correspondingly small effort in order to accomplish the payment. Filling in a form that asks for the buyer's name, billing address, credit card number, credit card expiry date, and credit card security code is more work than most people are willing to perform in order to pay 25 cents. Given their drawbacks, the systems above are not well suited for micro-payments because they require a buyer to identify himself and/or his account at the time of making a payment. By practicing the teachings of the present invention, the effort to make a payment can be largely eliminated, to bring the effort in line with the small value of a micro-payment.

Clearly then, there is a need for an improved method, device and software to simplify order and payment for purchases.

### SUMMARY OF THE INVENTION

The present invention provides a method, device and software for allowing a buyer to order and pay for products with minimal action required on the part of the buyer.

In an embodiment, a display component displays to the buyer a product available for purchase from a merchant through a merchant computing device. A purchase order component is configured to send to the merchant, in response to a single purchasing action taken by the buyer to purchase a product displayed by the display component, a purchase order for the product by way of a data network. A value storage component under control of the buyer stores data representative of a currency of an issuer, verifiable as representing the currency by the merchant. The value storage component is configurable to electronically transfer data representative of an amount of the currency in response to a request from the merchant.

In an aspect of the present invention, there is provided a buyer computing device operable by a buyer for purchasing a product from a merchant by way of a data network, comprising a network interface component for exchanging data by way of the data network; a display component for displaying a product available for purchase from the merchant through a merchant computing device; a purchase order component configured to send to the merchant, in response to a single purchasing action taken to purchase a product displayed by the display component, a purchase order for the product by way of the data network; and a value storage component for electronically storing data representative of a currency of an issuer, and verifiable as representing the currency by the merchant, the value storage component being configurable to electronically transfer data representative of an amount of the currency to the merchant in response to the single purchasing action.

In another aspect of the invention, there is provided a client-server system for purchasing a product available from a merchant by way of a data network. The system comprises, on a buyer client computing device, a network interface component for exchanging data by way of the data network; a display component for displaying a product available for purchase from the merchant through a merchant computing device; a purchase order component configured to send to the merchant, in response to a single purchasing action taken to purchase a product displayed by the display component, a purchase order for the product by way of the data network; a value storage component for electronically storing data representative of a currency of an issuer, and verifiable as representing the currency by the merchant. The system comprises, on a merchant operated server computing device, a network interface component for exchanging data by way of the data network; a payment handler component configurable to request from the value storage component electronic transfer of data representative of an amount of the currency to the merchant in response to the single purchasing action.

In another aspect of the invention, there is provided a method of purchasing a product from a merchant by way of a data network comprising, on a network enabled buyer computing device, providing a display component for displaying a product available for purchase from the merchant through a merchant computing device; providing a purchase order component for sending to the merchant, in response to a single purchasing action taken to purchase a product displayed by the display component, a purchase order for the product by way of the data network; providing a value storage component for electronically storing data representative of a currency of an issuer, and verifiable as representing the currency by the merchant, the value storage component being configurable to electronically transfer data representative of an amount of the currency to the merchant in response to the single purchasing action.

In another aspect of the invention, there is provided a computer readable medium, storing computer executable software instructions that when loaded at a buyer computing device comprising a processor and processor readable memory adapt the buyer computing device to provide a display component for displaying a product available for purchase from the merchant through a merchant computing device; provide a purchase order component for sending to the merchant, in response to a single purchasing action taken to purchase a product displayed by the display component, a purchase order for the product by way of the data network; provide a value storage component to electronically store data representative of a currency of an issuer, and verifiable as representing the currency by the merchant, the value storage component being configurable to electronically transfer data representative of an amount of the currency to the merchant in response to the single purchasing action.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 illustrates the major components of an order and payment method and system and their interactions during a payment process;

FIG. 2A shows a possible presentation of products for sale on an Internet site, which may be paid for in a conventional manner;

FIG. 2B shows a possible presentation of products for sale on an Internet site, in manners exemplary of an embodiment of the present invention;

FIG. 3 shows an enhanced version of the method and system of FIG. 1, adding an authorization list component;

FIG. 4 illustrates an alternative embodiment of the method and system illustrated in FIG. 1.

### DETAILED DESCRIPTION

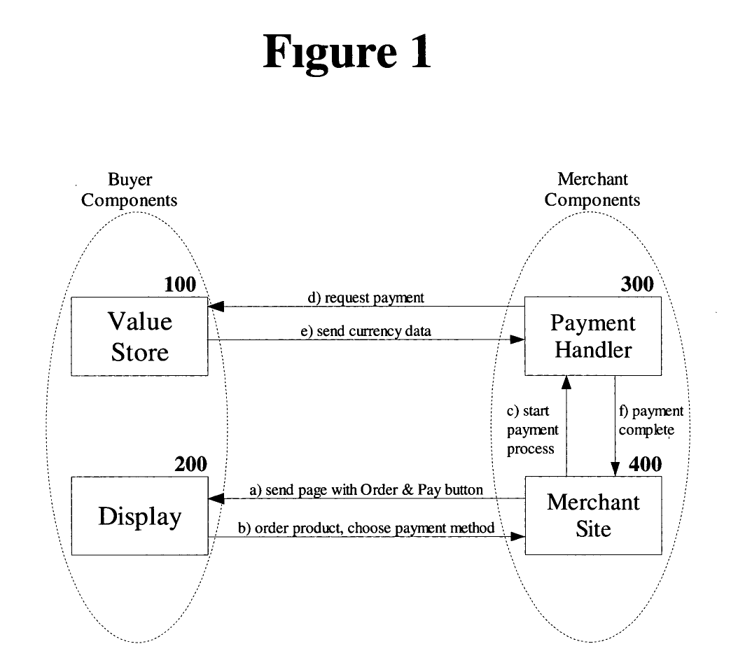

FIG. 1 schematically illustrates major software components (value store 100, display 200, payment handler 300, and merchant site 400), exemplary of embodiments of the present invention, and communication channels between them. Value store 100 and display 200 are typically pieces of software that reside on and execute their operations within a buyer's personal computer. Payment handler 300 and merchant site 400 are typically pieces of software that reside on server computers operated by or for a merchant that sells its products over the Internet.

Specifically, value store 100 and display 200 run on a personal computer. This computer may be a desktop personal computer, a notebook computer, a hand held digital assistant (e.g. Palm Pilot), a cell phone, or any other electronic devices including a credit card sized smart card that is able to deliver the necessary functionality.

Display 200 is a piece of software separate from, but running on the same computer as, value store 100, but this is not necessary. The functionality of the display 200 and value store 100 may be combined into a single piece of software running on one computer, or split into two or more pieces of software running on one or more computers which communicate with each other in order to accomplish the buyer side of a payment.

Payment handler 300 and merchant site 400 may be on the same computer or on two or more computers which communicate with each other in order to accomplish the merchant side of a payment. Payment handler 300 and merchant site 400 may be integrated to become a single process on one computer.

Network Infrastructure

In the illustrative embodiment, the computers hosting software components 100, 200, 300, and 400 may be inter-connected by a conventional computer network communications infrastructure. For example, the communications network infrastructure may be a packet switched data network, compliant with standard protocols which make up the Internet and the World-Wide Web, including the Internet Protocol (IP), Transport Control Protocol (TCP), Hyper-Text Transfer Protocol (HTTP), and others.

Each component 100, 200, 300, 400 may include a network interface component which provides this ability to communicate with one or more other components 100, 200, 300, 400, as shown in the drawings and described herein. For example, the network interface component in each of 100, 200, 300 and 400 may include TCP/IP protocol stacks, which protocol stacks are often included as part of conventional computer operating systems. In the illustrative embodiment, the network interface component also includes the ability to communicate via software using HTTP.

Value Store

Value store 100 stores data representative of a currency of an issuer (herein shortened to “currency data” for brevity). As will become apparent, value store 100 is configurable to electronically receive a request for payment and to electronically transfer currency data to a merchant.

The value store 100 may include, or be in communication with, an authorization component. Before value store 100 transfers currency data to a merchant, it may use its authorization component to determine whether a particular payment should be performed. This authorization component interacts with the authorization list 101 as disclosed herein.

Those skilled in the art will realize that there are several ways to represent currency data. One example of a way to represent currency data is described in U.S. Pat. No. 5,999,625 (Bellare et al.), where currency data is referred to as a “coin” or a “fund representation”, and consists of the following fields of data: an amount of the currency involved, an expiry date, a random 1024-bit coin ID, and a message authentication code computed using a symmetric key (randomly chosen by the issuer and kept in secret by the issuer). In an illustrative embodiment, a value store 100 uses the network infrastructure to communicate with an issuer, requests that the issuer send some currency data to the value store 100, and then receives the currency data over the same network infrastructure.

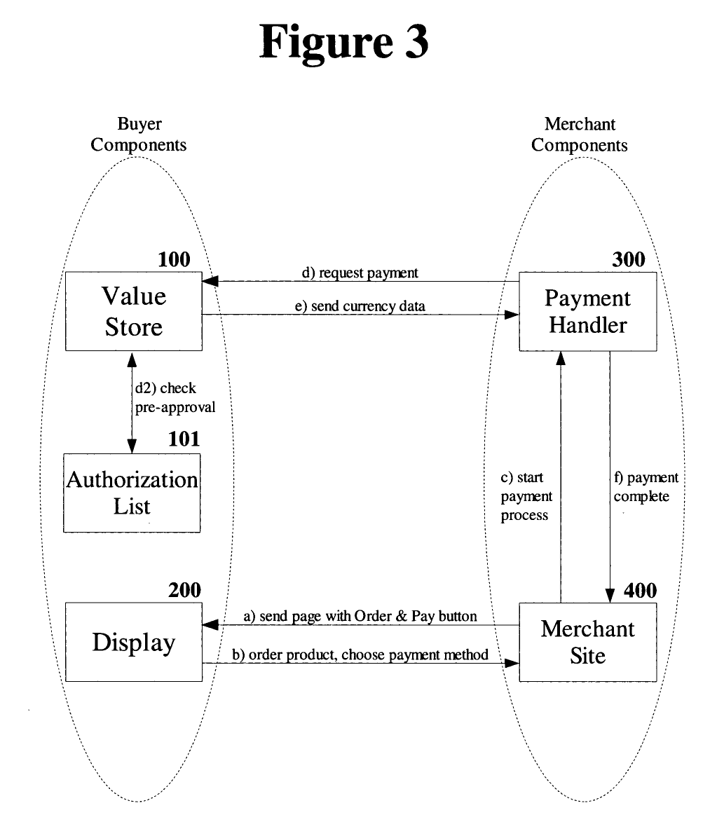

Those skilled in the art will realize that there are several ways that value store 100 can be implemented, using enhancements to known technologies. By way of example, the DigiCash (TM) electronic cash product provides a client wallet for performing the functions of storing currency data and responding to requests for payment. Similarly, a user purse described in U.S. Pat. No. 5,999,625 (Bellare et al.) is also able to store currency data and respond to requests for payment. The enhancements may include, for example, using different network infrastructure protocols to support communications in another type of network. Another enhancement is to support creation of an authorization list 101 for use in conjunction with value store 100 (discussed below and illustrated in FIG. 3).

Currency data may be verifiable as representing a specific amount of a particular currency by the merchant that receives the currency data. Depending on the particular way chosen to represent currency data, the merchant may be able to examine the data and directly determine its validity, or alternatively the merchant may require the assistance of a third party or the issuer of the currency. An example of currency data that can be verified by the merchant is the electronic money described in U.S. Pat. No. 5,453,601 (Rosen). An example of currency data that is verified by sending it to the issuer is described in U.S. Pat. No. 5,999,625 (Bellare et al.).

Value store 100 typically also provides an appropriate user interface to enable a buyer to control its operations including requesting currency data from an issuer, sending currency data to a merchant, and managing an authorization list

Display

Display 200 is a component which is able to receive pages of information sent over a communications network and then display them to a person, such as a buyer. Display 200 also enables a person viewing a page to perform actions, like pressing keys on a keyboard or clicking a pointing device, to send information back to the sender of the page, such as a web site.

In an embodiment, display 200 is a conventional web browser, used to view pages of information formatted using hyper-text markup language (HTML) or other page description language, and sent over the Internet. The web browser interprets HTML commands and displays pages on a display device as they are supposed to appear. Two commonly used browsers are Microsoft's Internet Explorer and Netscape Navigator.

In an embodiment, display 200 runs on the same computer as value store 100. The computer on which they run may be a personal computer under the control of the buyer.

Purchase Order Component

The buyer of a product should be able to convey to the merchant what product(s) the buyer wishes to buy. This information about the product(s) to be purchased is referred to as a purchase order. The purchase order information typically describes the product to be purchased in normal commercial terms and contains any additional information the merchant needs to process the order. This information may be as little as just a product identifier, or it may be supplemented by description, quantity, or other information useful to the buyer or merchant.

In an embodiment of the invention, the purchase order component under the control of the buyer conveys the purchase order to the merchant. In addition to sending the purchase order, this component also sends to the merchant an indication, explicit or implicit, that the buyer wishes to pay for the purchase using his value store 100.

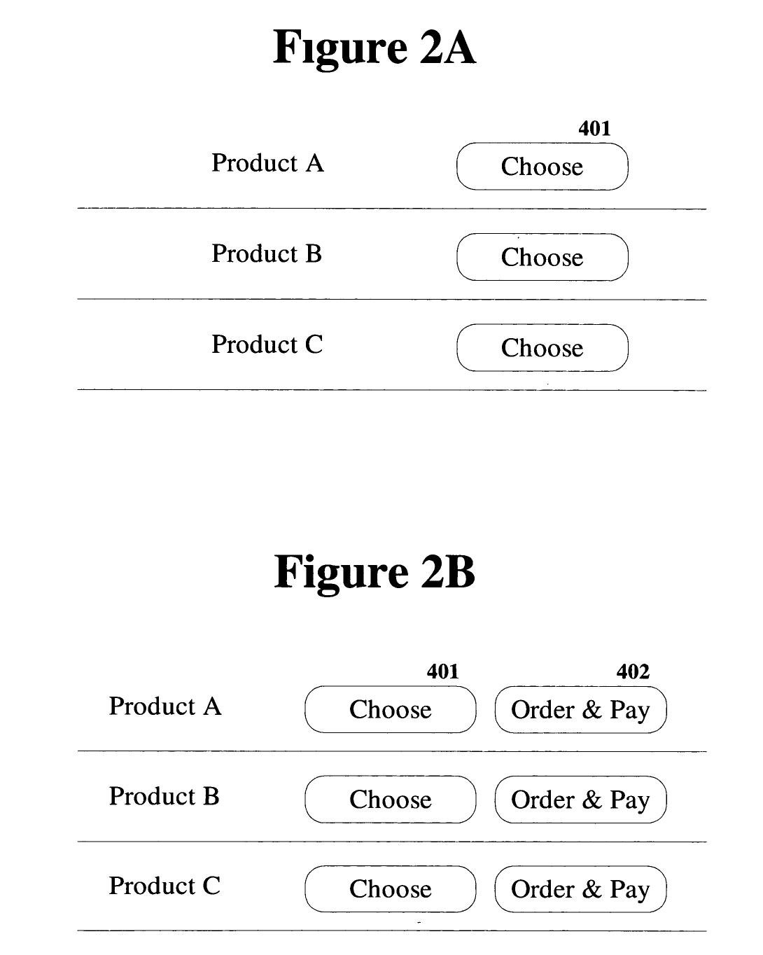

In an embodiment, the purchase order component is implemented using HTML embedded in a page sent to display 200 by merchant site 400. An order & pay 402 button (see FIG. 2B and the additional description below), presented by HTML coding, sends to merchant site 400 a purchase order which contains a product number that identifies the particular product being ordered and also indicates that the buyer wishes to pay using the buyer's value store 100. Since merchant site 400 originally created the HTML coding being executed by display 200, it knows what product the product number identifies. In accordance with the teachings of the present invention, the clicking of the order & pay 402 button by the buyer also instructs the merchant device that the payment is to be made using the buyer's value store 100.

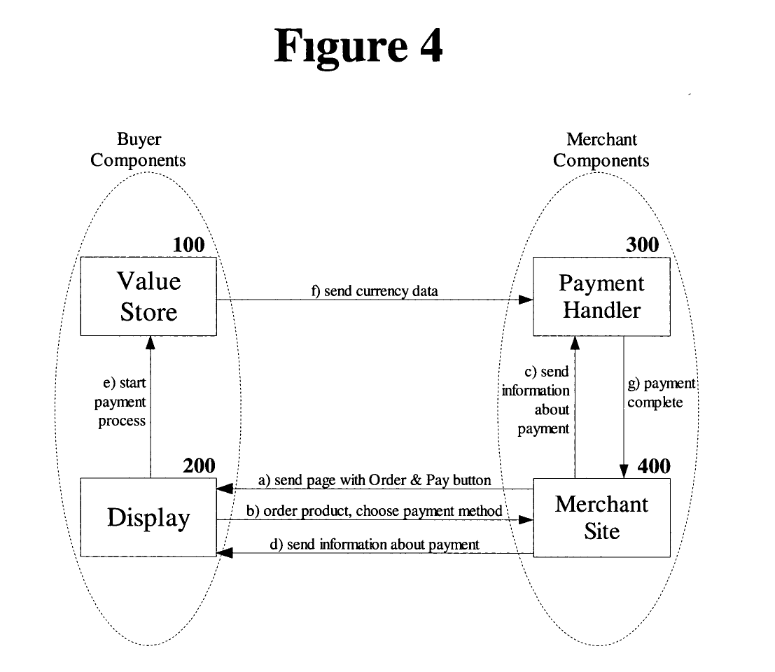

It will be apparent to those skilled in the art that there are many other ways to build this purchase order component. For example, one of the additional embodiments, described below and illustrated with reference to FIG. 4, explains that value store 100 itself can initiate communication with payment handler 300. That embodiment could be enhanced to enable value store 100 to also contain the purchase order component which sends the purchase order to the merchant.

Merchant

A merchant operates components which can send information about products that are for sale, accept purchase orders for these products, request payment for the products, and accept payment sent to the merchant from the buyer in the form of currency data. In an embodiment, the merchant operates two major components: a merchant site 400 and a payment handler 300.

Merchant Site

Merchant site 400 sends to a buyer display 200 information about the products a merchant has for sale, and enables a buyer to select products the buyer wishes to purchase. Merchant site 400 allows a buyer using display 200 to indicate how the buyer wishes to make a payment. In accordance with an embodiment of the invention, if the buyer chooses to order and make a payment, merchant site 400 may send commands and information to other components (e.g. to payment handler 300) and wait for a response indicating whether payment was successful or not.

In an embodiment, merchant site 400 is a web server hosting a web site that sends HTML pages to display 200 (e.g. on a buyer's personal computer). In an embodiment, the merchant site 400 communicates with payment handler 300 by messages which are initiated either by a CGI script, or by a servlet which is launched by an HTML message.

Payment Handler

Payment handler 300 is a component that is able to accept commands from and respond to merchant site 400. It is also able to send requests to and receive currency data from value store 100. It coordinates activities relating to payments on the part of the merchant.

A software component embodying payment handler 300 may be written that performs the following steps (error condition and timeout processing are omitted to make the flow more understandable):
a) Await requests from merchant site 400.
b) Receive a request from merchant site 400 to obtain payment. This request would minimally include the price (e.g. amount and currency) of the requested payment, and the location (e.g. network address) of value store 100 from which to seek payment. In most practical business contexts, the payment request will also include invoice information describing the products being purchased, and security information which will depend on the nature of value store 100 and the network infrastructure being used.
c) Send a request for payment to value store 100. This request will typically include the same information as was in the request received from merchant site 400.
d) Await a response from value store 100. The response includes currency data sent by value store 100 for payment, which currency data represents an amount of currency sufficient to pay the price of the product purchased.
e) Examine the received currency data to ensure it is legitimate. Depending on the type of value store 100 being used, this may entail sending messages to the issuer of the currency stored at value store 100 or other systems. Performing of other processing (if any) will be dictated by the nature of the value store 100 and its representation of currency data.
f) If the currency data is legitimate, then respond to the original request from merchant site 400, indicating that payment has been completed.
   Order and Pay With a Single Purchasing Action

FIGS. 2A and 2B each show a possible presentation of information about products for sale. This list of products could be presented as a page sent by merchant site 400 to be displayed by display 200.

FIG. 2A shows how a merchant site 400 might present products for sale in a conventional manner. Beside each product is a means of selecting the product, in the form of a button labeled “choose” 401. This button would provide the traditional function on a merchant web site of adding the indicated product to a notional shopping cart. This shopping cart is actually a list of items selected by the buyer as the buyer moves from place to place in the web site, examining different products being offered for sale. The list is usually maintained by the computers at the merchant's web site. When the buyer decides to stop selecting products and to proceed to pay for them, this list of previously selected items can be presented to the buyer and their total value calculated so that the correct amount can be paid.

In contrast, in exemplary of an embodiment of the present invention, the merchant presents an additional or alternative means for selecting each item and paying for it at the same time. This means could be visually presented as an additional selectable button beside each item, as depicted in FIG. 2B and labeled “order & pay” 402. In another embodiment, the choose 401 button could be omitted and only the order & pay 402 button may be present.

Instead of performing separate actions to add a product to a shopping cart, to indicate a desire to check out, to choose a payment mechanism, and then to perform the actions needed to fulfill the requirements of the selected payment mechanism, choosing a single order & pay 402 action can accomplish all these actions at once.

In an embodiment, selecting the order & pay 402 button causes a message to be sent to merchant site 400 which in turn causes merchant site 400 to perform the following:
a) recognize the product that the buyer wants to purchase;
b) send a message to payment handler 300 telling it to request payment from the buyer's value store 100;
c) accept payment when it arrives;
d) arrange delivery of the product to the buyer.
   Examples of Operation

Examples of operation of the various components described above, in accordance with various illustrative embodiments of the invention, are now provided.

Referring back to the steps in FIG. 1 (steps correspond to arrow labels in FIG. 1), ordering a product and paying for it would proceed as follows:
a) Merchant site 400 transmits to display 200 information about products available for sale. As depicted in FIG. 2B, beside each product is an order & pay 402 button. Each such button contains within it information about the product that it corresponds to, and information to indicate that the buyer wants to pay using his value store 100.
b) The buyer uses display 200 to examine information about a merchant's products. When the buyer has decided which product he wishes to order and pay for, the buyer uses display 200 to select the corresponding order & pay 402 button. This causes display 200 to send a message to merchant site. This message identifies the product to be purchased, and that the buyer wishes to pay by sending currency data from the buyer's value store 100.
c) Merchant site 400 starts the payment process by sending a message to payment handler 300. The message indicates the amount that must be collected from the buyer to pay for the products he has selected, and typically provides additional information to enable the buyer to identify the merchant and the products chosen. While payment handler 300 is processing the payment, merchant site 400 waits for a response indicating the success or failure of the payment.
d) Payment handler 300 sends a request for payment to the value store 100 associated with the buyer who is using display 200. This request for payment specifies the price that must be paid for the product that was ordered. In a typical embodiment, for security reasons, this request for payment additionally contains information that identifies the merchant and the product being purchased.
e) In response to the request from payment handler 300, value store 100 sends an appropriate amount of currency data to payment handler 300. Typically, when a value store 100 sends currency data to a payment handler 300, it records which currency data was sent so that the value store 100 will not send the same currency data for a subsequent payment transaction. If the value store 100 does not hold and cannot obtain sufficient or the right kind of currency data, then value store 100 responds to payment handler 300 indicating that the payment cannot be made; this effectively ends the transaction, and payment handler 300 would inform merchant site 400 of this.
f) If value store 100 sent appropriate currency data to payment handler 300, then payment handler 300 informs merchant site 400 that the payment has been received. Merchant site 400 then does whatever it needs to do to deliver the product to the buyer. This may entail arranging to ship physical goods, or to transmit electronic information, or to allow the buyer to play a game, watch a movie, or listen to a song being downloaded (streamed) over the Internet.

Advantageously, in many cases where the product being sold by the merchant is in electronic form, a buyer can select, pay for, and receive the product all with a single action. For, example the buyer may easily obtain and pay for download data including audio data, video data, image data, text data and executable data. This data may be available, for example, on a per access basis, or alternatively on a consumption basis based on at least one of time, data volume, and bandwidth usage.

Depending on the manner in which the merchant has made the data available, the authorization component is configurable to authorize the value store 100 to transfer sufficient amounts of currency data to pay for download of data made available on a per access or consumption basis. In an alternative embodiment, the authorization component is configurable to authorize the value store 100 to repeatedly transfer sufficient amounts of currency data to pay the consumption based charges.

With these improvements, the buyer perceives that his effort is being spent to choose the product, and the payment part of the process becomes largely invisible to the buyer (although it still happens as a consequence of the currency data sent by the buyer's value store 100 to the merchant's payment handler 300). This approach to eliminating virtually all effort required to make payments does not depend on the buyer having an account with the merchant or establishing any sort of relationship in advance; unlike other payment mechanisms, this can be done without the merchant knowing who the buyer is.

Pre-Approve Selected Merchants

As described above, a value store 100 receives requests from merchants and responds by sending currency data. However, in order to prevent the payment handler 300 from withdrawing unapproved amounts, the buyer may wish to have an enhanced security feature (such as confirmation of payment). While such confirmation could be facilitated by receiving a message on display 200, and asking the buyer to confirm payment (e.g. by clicking a button) before the currency data is sent, this constitutes an extra step.

In an alternative embodiment, shown in FIG. 3, value store 100 may have an authorization list 101, the contents of this authorization list 101 being provided by the buyer. For example, authorization list 101 may include a list of merchants that the buyer has approved for payment. Authorization list 101 is normally maintained in a persistent storage medium and is under the control of the buyer whose money is being managed by value store 100. The buyer can add entries to the list and remove entries from the list.

A single entry in the list contains information to identify a merchant site 400 component that may send payment requests, via payment handler 300, to value store 100. In an embodiment merchant site 400 may be identified using its public key infrastructure (PKI) certificate(s) issued by a well-known certificate authority. In an embodiment, the payment request message (step d) in FIG. 3) includes the PKI certificate of the merchant site 400.

Value store 100 uses the authorization list 101 as follows: If a payment request comes from payment handler 300 (step d) in FIG. 3), value store 100 examines the authorization list 101 (step d2) in FIG. 3) to see if the merchant site 400 that is requesting payment has been identified by an entry in the authorization list 101. If a merchant site 400 is so identified, then value store 100 knows that the buyer has approved payments to the identified merchant. Therefore value store 100 does not need to ask the buyer for approval of the payment.

The result of this enhancement of a value store 100 with an authorization list 101 is that payment handler 300 can send a request for payment to value store 100 which, in turn, can send the payment, all without any further confirmation from the buyer.

As described above, authorization list 101 may use PKI certificates as a way to identify merchant site 400 for future payment requests, saving the certificates in the authorization list 101. However, merchant identification could be done in many other ways, such as by examining the merchant's name, recognized merchant number, network address, URL, or some other identification mechanism, or a combination of these. It will be recognized that using an encrypted system, such as PKI certificates, is more secure. It is also possible to accomplish this function using an identification technology that has not yet been invented. In an embodiment in which the value store 100 uses these alternative means to identify a merchant site 400, the payment request message (step d) in FIG. 3) includes the alternative information being used.

Advantageously, the buyer is in complete control of authorization list 101, which resides on his own computer or is on another computer under his control. This enables the buyer to remove a merchant from the authorization list 101 whenever desired, thereby immediately and unconditionally stopping pre-approved payments to a merchant.

Additional Embodiments

The arrangement of various components and their interactions as described above is not intended to limit the invention. Modifications will be apparent to those skilled in the art. This section contains a partial list of some of the variations that could be implemented.

Different possible implementations were identified for value store 100 and the currency data that it holds. As described, depending on which is implemented, payment handler 300 may be able, without assistance from other components, to determine the validity of the payment received from value store 100. Alternatively, payment handler 300 may need to refer to another system, perhaps run by an external authority like a bank that issues electronic cash, to determine the validity of the payment. This reference to an external authority may require extra steps in the order and payment process.

Value store 100 may contain electronic representations of money or other representations of value. This value may be cash, perhaps designated in United States dollars or any other nation's currency. It may be some other representation of points, air travel miles, loyalty points, commodities like gold, stocks, bonds, or other value that will be accepted as a form of payment by the merchant.

Another extension from the above description is making the order & pay 402 button cause a sequence of payments. This might be desired if the total amount that needs to be paid cannot be determined in advance. For example, if the product being purchased is streaming information (e.g. stock quotes, classical music, a movie), then the cost might be $1 per hour of viewing or listening. The order & pay 402 button could cause an initial payment of $1, and cause the stream of information to start flowing to the buyer, and the button could additionally cause the merchant to request payment of $1 every hour afterwards until the buyer stops using the streaming information.

Many interactions between components of the system are described as a message containing several data elements. Such a single message could be implemented as a sequence of messages each containing a subset of the data elements.

Message interactions between two components of the system, which are described as being direct, could be indirect. For example if component A directly sends a message to component C, this interaction could be accomplished by component A sending a message to component B with an indication, explicit or implicit, that part or all of the message should be forwarded to component C. As an illustration of this possibility, in FIG. 1, step b) entails the display 200 sending a message to the merchant site 400. This message flow could be directed from the display 200 to the value store 100 which in turn could forward the message to the merchant site 400.

In an embodiment, communication between the modules that make up the system is done using Internet communications. The communication could, in an alternate embodiment, be done using radio, satellite, infra-red, wireless, telephonic, or other wired communication media.

The product being paid for is not limited to products that can be delivered directly over the Internet. The product may, for example, be a ticket (that may need to be printed by the buyer) that provides access to a product or service, online or not. The product may be one that must be shipped somewhere as directed by the buyer.

Buyer selection actions are described as clicks on buttons. These clicks can be replaced by any of several different types of actions as long as the actions suffice to indicate the buyer's intentions. For example, a selection action on any pointer device, a voice command, a key press, a button or toggle or slide may be activated on a keyboard or on a wireless device.

In an embodiment, authorization list 101 and value store 100 may be configured to authorize payment up to a maximum predetermined amount or number of purchase transactions. For example, this maximum may be specified per merchant site 400, or per purchase transaction.

Authorization list 101 and value store 100 could be configured to allow a buyer to control the effect of all the list entries as a group, such as: the maximum amount of currency data allowed in all transactions that are approved by any entry in the whole list; or the maximum number of transactions that should be allowed by the whole list. These enhancements provide a buyer with greater control over the payment authorization that is enabled by the authorization list 101.

Some merchants may operate more than one merchant site 400. The authorization list 101 could be altered so that its entries identify merchants, instead of or in addition to identifying the sites operated by them, so that a single authorization list 101 entry could provide approvals for purchases from more than one merchant site 400.

A single payment handler 300 could gather payments on behalf of many merchant sites 400. In this situation, the authorization list 101 could be altered so that its entries identify payment handlers 300 instead of or in addition to merchant sites 400.

Value store 100 may be segmented into different groupings of value, e.g. by currency (e.g. U.S. dollars, Canadian dollars, Euros); or by issuer; or both. The buyer may be asked to configure value store 100, explicitly or implicitly, to choose the value for a particular payment from one or more of these segments. Information may be added to the authorization list 101 to indicate that purchases from certain merchants should choose value from a specific segment or group of segments.

In an embodiment, the information about the products available for purchase and the buyer's selection of products to purchase are done by means of display 200 which uses HTML to describe pages of information and interaction with the buyer. It is possible to perform these interactions between the merchant and the buyer using custom software instead of a standard browser. The information sent to the buyer does not need to be represented using any particular page presentation mechanism: HTML can be replaced by Adobe's PDF, by XML, or any other page description mechanism.

In FIG. 1, step c) entails merchant site 400 informing payment handler 300 that it should start communicating with value store 100. The conversation between value store 100 and payment handler 300 could be initiated in many different ways. For example, it could be initiated by merchant site 400 or display 200 telling value store 100 to start a conversation with payment handler 300. FIG. 4 illustrates one of several possible approaches to this alternative embodiment, the steps (identified in FIG. 4) being as follows:
a) Merchant site 400 transmits to display 200 information about products available for sale.
b) The buyer uses display 200 to indicate that he wishes to order and pay using the method described by this invention.
c) Merchant site 400 sends information about the payment to payment handler 300, so that payment handler 300 will recognize the order and payment it is about to receive.
d) Merchant site 400 sends information about the payment to display 200 to enable it to tell value store 100 to start the payment process. This information may, for example, include information about how to contact payment handler 300.
e) Display 200 sends payment information details to value store 100.
f) Value store 100 sends currency data to payment handler 300.
g) Payment handler 300 informs Merchant site 400 that payment has been completed.

In FIG. 2B, beside each product there is a choose 401 button and also an order & pay 402 button. These could be merged into a single button. Activation of this specially programmed button could examine the client computer to determine whether it has an appropriate value store 100, and if there is such a value store 100, then the button could act like a order & pay 402 button. Alternatively, if there is no appropriate value store 100 installed on the buyer's computer, then the button could act like a choose 401 button, perhaps adding the selected product to a notional shopping cart mechanism.

The explanation and discussion of exemplary embodiments of the invention describes its use to purchase a product from a merchant. It can additionally be used for any type of transfer of value from one party to another. Examples of other types of payments include: a payment from one individual to another; or a payment to a charity which does not deliver a product to the payer. The invention describes the interaction of selection of a product, and paying for it; but some merchants sell only one product in which case only the payment transfer portions of this invention would be used.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims, and their equivalents.

1. A buyer computing device operable by a buyer for purchasing a product from a merchant by way of a data network, comprising:
a network interface component for exchanging data by way of the data network;
a display component for displaying a product available for purchase from the merchant through a merchant computing device;
a purchase order component configured to send to the merchant, in response to a single purchasing action taken to purchase a product displayed by the display component, a purchase order for the product by way of the data network;
a value storage component for electronically storing data representative of a currency of an issuer, and verifiable as representing the currency by the merchant, the value storage component being configurable to electronically transfer data representative of an amount of the currency to the merchant in response to the single purchasing action.

2. The buyer computing device of claim 1, wherein the purchase order component is configured to send the purchase order to the merchant computing device.

3. The buyer computing device of claim 1, wherein the value storage component is configurable to electronically transfer by way of the data network the data representative of the amount of the currency upon request from the merchant, the request being initiated in response to the single purchasing action.

4. The buyer computing device of claim 3, wherein the value storage component is operable to receive the request from the merchant computing device.

5. The buyer computing device of claim 3, wherein the value storage component is operable to receive the request from a computing device separate from the merchant computing device.

6. The buyer computing device of claim 1, further comprising an authorization component, the authorization component being configurable to authorize the value storage component to transfer to the merchant, by way of the data network, the data representative of an amount of the currency from the value storage component to complete the purchase order.

7. The buyer computing device of claim 6, wherein the authorization component is configurable to authorize transfer of the data representative of an amount of the currency to a maximum predetermined amount.

8. The buyer computing device of claim 6, wherein the authorization component is configurable to authorize transfer of sufficient amounts of the data representative of an amount of the currency to pay for download of data to the buyer computing device by way of the network.

9. The buyer computing device of claim 8, wherein the download of data comprises at least one of audio data, video data, image data, text data and executable data.

10. The buyer computing device of claim 6, wherein the authorization component is configurable to authorize repeated transfer of sufficient amounts of the data representative of an amount of the currency to pay consumption based charges for the product.

11. The buyer computing device of claim 10, wherein the consumption based charges are based on at least one of time, data volume, and bandwidth usage.

12. The buyer computing device of claim 1, wherein the single purchasing action is one of selection of an object, generation of a sound, and depression of a key.

13. The buyer computing device of claim 1, wherein the data representative of the amount of the currency is untraceable to the buyer.

14. The buyer computing device of claim 1, wherein the display component comprises a world wide web compatible browser to display a merchant web page offering the product available for purchase, received by way of the data network.

15. The buyer computing device of claim 14, wherein the purchase order component comprises code executable by the browser to enable a single purchasing action and to send to the merchant computing device the purchase order.

16. The buyer computing device of claim 15, wherein the single purchasing action is enabled by one of selection of an object, generation of a sound, and depression of a key.

17. The buyer computing device of claim 1, wherein the data representative of a currency of an issuer is cryptographically encoded.

18. The buyer computing device of claim 1, wherein the data representative of a currency of an issuer is verifiable without assistance of the issuer.

19. The buyer computing device of claim 1, wherein the data representative of a currency of an issuer is verifiable by a third party.

20. A client-server system for purchasing a product available from a merchant by way of a data network, the system comprising,
on a buyer client computing device:
a network interface component for exchanging data by way of the data network;
a display component for displaying a product available for purchase from the merchant through a merchant computing device;
a purchase order component configured to send to the merchant, in response to a single purchasing action taken to purchase a product displayed by the display component, a purchase order for the product by way of the data network;
a value storage component for electronically storing data representative of a currency of an issuer, and verifiable as representing the currency by the merchant;
on a merchant operated server computing device:
a network interface component for exchanging data by way of the data network;
a payment handler component configurable to request from the value storage component electronic transfer of data representative of an amount of the currency to the merchant in response to the single purchasing action.

21. A method of purchasing a product from a merchant by way of a data network, comprising:
on a network enabled buyer computing device:
providing a display component for displaying a product available for purchase from the merchant through a merchant computing device;
providing a purchase order component for sending to the merchant, in response to a single purchasing action taken to purchase a product displayed by the display component, a purchase order for the product by way of the data network;
providing a value storage component for electronically storing data representative of a currency of an issuer, and verifiable as representing the currency by the merchant, the value storage component being configurable to electronically transfer data representative of an amount of the currency to the merchant in response to the single purchasing action.

22. The method of claim 21, further comprising configuring the purchase order component to send the purchase order to the merchant computing device.

23. The method of claim 22, further comprising configuring the value storage component to electronically transfer by way of the data network the data representative of the amount of the currency upon request from the merchant, the request being initiated in response to the single purchasing action.

24. The method of claim 23, further comprising initiating the request from the merchant from a payment receiving component on the merchant computing device.

25. The method of claim 23, further comprising initiating the request from the merchant from a payment receiving component on a computing device separate from the merchant computing device.

26. The method of claim 21, further comprising providing an authorization component configurable to authorize the value storage component to transfer to the merchant, by way of the data network, the data representative of an amount of the currency from the value storage component to complete the purchase order.

27. The method of claim 26, further comprising configuring the authorization component to authorize transfer of the data representative of an amount of the currency to a maximum predetermined amount.

28. The method of claim 26, further comprising configuring the authorization component to authorize transfer of sufficient amounts of the data representative of an amount of the currency to pay for download of data to the buyer computing device by way of the network.

29. The method of claim 28, wherein the download of data comprises at least one of audio data, video data, image data, text data and executable data.

30. The method of claim 26, further comprising configuring the authorization component to authorize repeated transfer of sufficient amounts of the data representative of an amount of the currency to pay consumption based charges for the product.

31. The method of claim 30, further comprising basing the consumption based charges on one of time, data volume, and bandwidth usage.

32. The method of claim 21, further comprising effecting the single purchasing action by one of selection of an object, generation of a sound, and depression of a key.

33. The method of claim 21, further comprising configuring the data representative of the amount of the currency to be untraceable to the buyer.

34. The method of claim 21, wherein the display component comprises a world wide web compatible browser, and the method further comprises displaying a merchant web page offering the product available for purchase, received by way of the data network.

35. The method of claim 34, further comprising configuring the purchase order component as code executable by the browser to enable a single purchasing action and to send to the merchant computing device the purchase order.

36. The method of claim 35, further comprising effecting the single purchasing action by one of selection of an object, generation of a sound, and depression of a key.

37. The method of claim 21, wherein the data representative of a currency of an issuer is verifiable by a third party.

38. A computer readable medium, storing computer executable software instructions that when loaded at a buyer computing device comprising a processor and processor readable memory adapt the buyer computing device to:
provide a display component for displaying a product available for purchase from the merchant through a merchant computing device;
provide a purchase order component for sending to the merchant, in response to a single purchasing action taken to purchase a product displayed by the display component, a purchase order for the product by way of the data network;
provide a value storage component to electronically store data representative of a currency of an issuer, and verifiable as representing the currency by the merchant, the value storage component being configurable to electronically transfer data representative of an amount of the currency to the merchant in response to the single purchasing action.

39. The computer readable medium of claim 38, wherein the software instructions further adapt the buyer computing device to configure the purchase order component to send the purchase order to the merchant computing device.

40. The computer readable medium of claim 38, wherein the software instructions further adapt the buyer computing device to configure the value storage component to electronically transfer by way of the data network the data representative of the amount of the currency upon request from the merchant, the request being initiated in response to the single purchasing action.

41. The computer readable medium of claim 40, wherein the software instructions further adapt the buyer computing device to maintain an authorization component, the authorization component being configurable to authorize the value storage component to transfer to the merchant, by way of the data network, the data representative of an amount of the currency from the value storage component to complete the purchase order.

42. The computer readable medium of claim 41, wherein the software instructions further adapt the buyer computing device to configure the authorization component to authorize transfer of the data representative of an amount of the currency to a maximum predetermined amount.

43. The computer readable medium of claim 41, wherein the software instructions further adapt the buyer computing device to configure the authorization component to authorize transfer of sufficient amounts of the data representative of an amount of the currency to pay for download of data to the buyer computing device by way of the network.

44. The computer readable medium of claim 43, wherein the software instructions further adapt the buyer computing device to download data comprising at least one of audio data, video data, image data, text data and executable data.

45. The computer readable medium of claim 41, wherein the software instructions further adapt the buyer computing device to configure the authorization component to authorize repeated transfer of sufficient amounts of the data representative of an amount of the currency to pay consumption based charges for the product.

46. The computer readable medium of claim 45, wherein the software instructions further adapt the buyer computing device to base the consumption based charges on one of time, data volume, and bandwidth usage.

47. The computer readable medium of claim 38, wherein the software instructions further adapt the buyer computing device to effect the single purchasing action by one of selection of an object, generation of a sound, and depression of a key.

48. The computer readable medium of claim 38, wherein the software instructions further adapt the buyer computing device to configure the data representative of the amount of the currency to be untraceable to the buyer.

49. The computer readable medium of claim 38, wherein the display component comprises an HTML compatible browser, and the software instructions further adapt the buyer computing device to display a merchant web page offering the product available for purchase, received by way of the data network.

50. The computer readable medium of claim 49, wherein the software instructions further adapt the buyer computing device to configure the purchase order component as code executable by the browser to enable a single purchasing action and to send to the merchant computing device the purchase order.

51. The computer readable medium of claim 50, wherein the software instructions further adapt the buyer computing device to effect the single purchasing action by one of selection of an object, generation of a sound, and depression of a key.
